(19) United States
(12) Patent Application Publication
(10) Pub. No.: US 2009/0007048 A1
(43) Pub. Date: Jan. 1, 2009

(54) DESIGN STRUCTURE FOR A COMPUTER MEMORY SYSTEM WITH A SHARED MEMORY MODULE JUNCTION CONNECTOR

(76) Inventors: MOISES CASES, Austin, TX (US); Martin J. Crippen, Apex, NC (US); Daniel N. de Araujo, Cedar Park, TX (US); Bradley D. Herman, Cary, NC (US); Erdem Matoglu, Austin, TX (US); William R. Milani, Raleigh, NC (US); Bhyrav M. Mutnury, Austin, TX (US); Pravin Patel, Cary, NC (US); Nam H. Pham, Round Rock, TX (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/203,335

(22) Filed: Sep. 3, 2008

Related U.S. Application Data
(63) Continuation-in-part of application No. 11/733,960, filed on Apr. 11, 2007, now abandoned.

(51) Int. Cl. G06F 17/50

(52) U.S. Cl. 716/12

(57) ABSTRACT

A design structure embodied in a machine readable storage medium for designing, manufacturing, and/or testing a memory module system and DIMM connector is provided. A DIMM connector includes a plurality of DIMM sockets for receiving a corresponding plurality of DIMMs in a radially oriented, angularly spaced orientation. The DIMM sockets are connected in parallel at a memory module junction so that socket terminals of each DIMM socket are joined to the same relative terminal of all the other DIMM sockets along electronic pathways of substantially equal length. A memory controller selectively communicates with the DIMMs via the DIMM junction. By virtue of the improved topology, impedance within the DIMM connector may be better matched to minimize reflections and improve signal quality.

### CROSS-REFERENCE TO RELATED APPLICATION

This application is a continuation-in-part of co-pending U.S. patent application Ser. No. 11/733,960, filed Apr. 11, 2007, which is herein incorporated by reference.

### BACKGROUND OF THE INVENTION

1. Field of the Invention

The present invention is generally related design structures, and more specifically, design structures for the structure, electrical configuration, and topology of DDR2-based computer memory.

2. Description of the Related Art

Continued improvements in computer memory are needed in conjunction with advances in other aspects of computer system technology. Current industry standards limit the speed and performance of DDR2-based memory systems, for example. One reason speed and performance are limited in these memory systems is the degradation of signal quality due to reflections. Conventional DIMM (Dual In-line Memory Module) topology causes unwanted reflections in both read and write directions, which become significant at higher speeds. Many commercially available systems, therefore, are currently limited to speeds provided by four slot-per-channel 533 MHz DDR2.

Memory technology has been improving on several fronts. “Fully Buffered DIMM” (FBD) technology, for example, strives to improve memory performance by switching off inactive DIMMs and switching on active DIMMs to simulate a point-to-point net. However, the expense and thermal issues related to the corresponding use of an Advanced Memory Buffer (AMB) currently limit the desirability of FBD in the marketplace. Another recent development in memory technology is the use of a solid state switch at each DIMM to selectively disconnect load from the inactive DIMM. Switches have also been incorporated on the mother board, but this approach undesirably adds cycles to the DIMM access time.

In blade server configurations, such as IBM's BladeCenter®, VLP (“Very Low Profile”) DIMM technology was introduced to reduce the height of a DIMM. However, VLP technology is currently more expensive than conventional configurations. Also, to increase memory capacity, a blade server configuration must use quad-rank DIMM, which also increases the costs.

Improved computer memory is desired in view of the limitations of existing technology. Aspects of improvement in computer memory might include, for example, increasing speed, while reducing cost and size. Compatibility with existing technology would also be desirable, such as an improved memory configuration that would not require a complete redesign of existing DIMM architecture.

### SUMMARY OF THE INVENTION

One embodiment of the invention provides a memory module system having a plurality of memory modules connected in parallel at a memory module junction in communication with a memory controller. The memory module junction electrically joins terminals of each memory module to the same relative terminals of the other memory modules along electronic pathways of substantially equal length.

In another embodiment, a connector body has a plurality of memory module sockets each configured for receiving a respective memory module. Each memory module socket has an ordered set of terminals for electronic engagement with a corresponding ordered set of terminals on the respective memory module. The connector includes a plurality of electronic pathways of substantially equal length that electronically connect terminals of corresponding order on the memory module sockets to a node.

In another embodiment, a design structure embodied in a machine readable storage medium for at least one of designing, manufacturing, and testing a design is provided. The design structure generally includes a memory module system, comprising a plurality of memory modules connected in parallel at a memory module junction in communication with a memory controller, wherein the memory module junction electrically joins terminals of each memory module to the same relative terminals of the other memory modules along electronic pathways of substantially equal length.

In yet another embodiment, another design structure embodied in a machine readable storage medium for at least one of designing, manufacturing, and testing a design is provided. The design structure generally includes a memory module connector, which includes a connector body having a plurality of memory module sockets each configured for receiving a respective memory module, each memory module socket having an ordered set of terminals for electronic engagement with a corresponding ordered set of terminals on the respective memory module; and a plurality of electronic pathways of substantially equal length electronically connecting terminals of corresponding order on the memory module sockets to a node.

Other embodiments, aspects, and advantages of the invention will be apparent from the following description and the appended claims.

### BRIEF DESCRIPTION OF THE DRAWINGS

FIG. 1 is a schematic diagram of a conventional memory system, having a four DIMM per channel DDR2 configuration.

FIG. 1A is an eye diagram of the voltage seen by the CPU in the conventional memory system of FIG. 1.

FIG. 2 is a schematic diagram of a memory system wherein the four DIMMs are configured with a more balanced topology according to the invention.

FIG. 2A is an eye diagram of the voltage seen by the CPU in the memory system of FIG. 2, demonstrating the improved signal quality.

FIG. 3 is a schematic diagram illustrating one example of a wiring configuration for the memory system.

FIG. 4 is a plan view of the DIMM including a row of 72 terminals consecutively designated t₁ to t₇₂.

FIG. 5 illustrates an alternative electrical configuration of four equal-length conductors joined at a node, wherein two of the conductors are joined at one location and the other two conductors are joined at another location away from the node.

FIG. 6 is a schematic diagram of the memory system illustrating the exemplary wiring diagram of FIG. 3, along with additional details about the wiring of the second ordered terminal set of each DIMM.

FIG. 7 provides a perspective view of the memory system of FIGS. 3 and 6.

FIG. 8 provides another perspective view of the memory system, inverted with respect to the view of FIG. 7.

FIG. 9 is a schematic diagram of an embodiment of a two-channel, six-DIMM memory system according to the invention.

FIG. 10 is a flow diagram of a design process used in mechanical design, manufacture, and/or test.

### DETAILED DESCRIPTION OF PREFERRED EMBODIMENTS

The present invention includes the provision of improved memory systems and devices for reducing or eliminating signal-degrading reflections encountered in conventional computer memory systems. In one embodiment, a “Quad Radial” DIMM connector connects up to four DIMMs in a radially oriented and angularly spaced orientation about a shared DIMM socket junction that provides parallel electronic I/O communication between each of the memory modules and a memory controller. A connector body includes four DIMM sockets each configured for receiving a respective DIMM. Each DIMM socket has an ordered set of terminals (“socket terminals”) for electrical engagement with a corresponding ordered set of terminals on the respective DIMM (“DIMM terminals”). The DIMM terminals may alternatively be referred to as pins. The DIMM sockets are connected in parallel to each other at the DIMM socket junction, so that socket terminals of each DIMM socket are joined to the same relative socket terminal of all the other DIMM sockets along electronic pathways of substantially equal length. Thus, socket terminals of “like order” (i.e., having the same relative position) provide electronic communication between the memory controller and the plurality of DIMMs via the nodes. The socket terminals of like order to be joined are typically I/O (input/output) type terminals, in that the equal-length electronic pathways are typically intended to carry I/O signals, such as data, strobe, and address, between the memory controller and the DIMMs. Other electronic pathways are for carrying input-only or output-only type signals, such as clock, termination control, chip select, and error reporting, between the memory controller and the DIMMs. Thus, socket terminals intended for input-only or output-only signals to or from the DIMMs are typically not joined with corresponding socket terminals.

In addition to connecting socket terminals of the same relative position along substantially equal path lengths, conductor impedances may be matched, so that, for example, impedance between the memory controller and one of the nodes is equal or similar to impedance between that node and the socket terminals of like order. This reduces or eliminates unwanted signal reflections to provide increased speed and performance. The improved signal quality also allows for more DIMMs per channel than are obtainable in conventional memory systems, so that, for example, as many as six DIMMs per channel may be connected to the memory controller via the DIMM socket junction.

The radially-oriented and angularly-spaced arrangement of DIMMs about a shared DIMM socket junction also reduces the footprint and height occupied by computer memory, to reduce the area and volume occupied by computer system memory. Smaller computer chassis are made possible, therefore, in conjunction with the use of Quad Radial DIMM connectors.

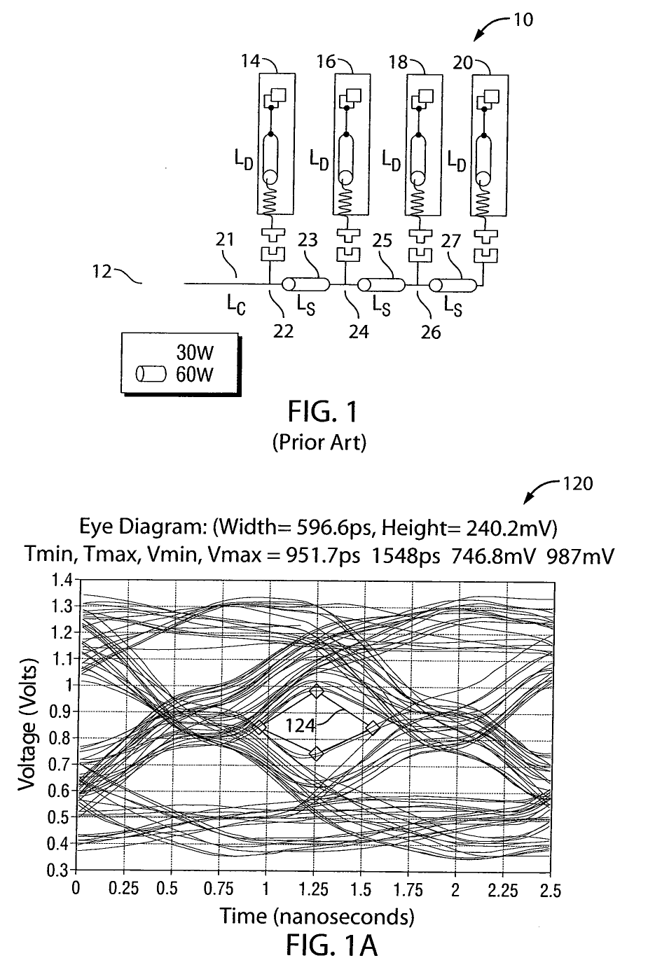

FIG. 1 is a schematic diagram of a conventional memory system 10, generally having a four DIMM per channel DDR2 configuration. This conventional “daisy chain” topology places a CPU 12 in communication with four memory modules 14, 16, 18, 20, which in this example are DIMMs 14, 16, 18, 20. The electronic configuration of the conventional memory system 10 includes a conductor (“CPU trace”) 21 and first, second, and third “DIMM spacing traces” 23, 25, 27. A key provided in the FIG. 1 identifies, by way of example and not by limitation, the nominal impedance (ohms) of the traces 21, 23, 25, 26. Communication signals between the CPU 12 and the first DIMM 14 travel through the first conductor trace 21 and a first node 22. Communication signals between the CPU 12 and the second DIMM 16 travel through the conductor trace 21, the first node 22, the first DIMM spacing trace 23, and a second node 24. Communication signals between the CPU 12 and the third DIMM 18 travel through the conductor trace 21, the first node 22, the first DIMM spacing trace 23, the second node 24, the second DIMM spacing trace 25, and a third node 26. Communication signals between the CPU 12 and the fourth DIMM 20 travel through the conductor trace 21, the first node 22, the first DIMM spacing trace 23, the second node 24, the second DIMM spacing trace 25, the third node 26, and the third DIMM spacing trace 28. As a result of this electronic configuration, the CPU 12 communicates with each of the four DIMMs 14, 16, 18, 20 along a different path length, and the communication signals between the CPU 12 and each of the four DIMMs 14, 16, 18, 20 encounter different impedances. The different path lengths and correspondingly different impedances contribute to signal reflections that limit the performance of the conventional memory system 10.

Impedance about the nodes 22, 24, 26 is significantly mismatched. For example, the impedance entering the first node 22 (Z₀) is the impedance of the conductor trace 21 (L_{C}), and the impedance exiting the node 22 is the combination of the impedance from the DIMM 14 (L_{D}) and the impedance from the DIMM spacing trace 23 (L_{S}). In this example, L_{C} is 30 ohms, while L_{S} and L_{D} are 60 ohms each. Thus, impedance is matched at the first node 22 Impedance entering the second node 24 is L_{S}, while impedance exiting the node 24 is L_{S}+L_{D}. Thus, the impedance at the second node 24 is mismatched by 50%. Similarly, impedance at the third node 26 is also mismatched by 50%. Mismatched impedance causes read/write signals to reflect. In this example, multiple reflections will occur back and forth in the topology, causing degraded signal quality. Impedance of the conductors 21, 23, 25, 27 generally depends on the lengths of the conductors. Thus, shortening the conductors 21, 23, 25, 27 may reduce but not eliminate the mismatch of impedance and associated reflections in the conventional memory system 10, because impedance is inherently mismatched by virtue of the conventional daisy chain topology.

The performance of a digital signal can be analyzed using an eye diagram. An eye diagram is an oscilloscope display known in the art in which a digital data signal is repetitively sampled, and the voltage is displayed as a function of time. An open eye pattern in the eye diagram corresponds to minimal signal distortion, whereas distortion and closure of the eye pattern indicates undesirable noise. FIG. 1A is an eye diagram 120 of the voltage seen by the DIMM 20 in the conventional memory system 10. The signal quality is poor, as indicated by a relatively small eye 124. The small eye 124 in this example has a width of 596.6 picoseconds and a height of 240.2 mV. The characteristics of the eye diagram 120 indicate the marginal signal quality obtained in the conventional memory system 10 of FIG. 1. The distortion will increase with increased memory speeds, making signal quality and corresponding memory performance unacceptable.

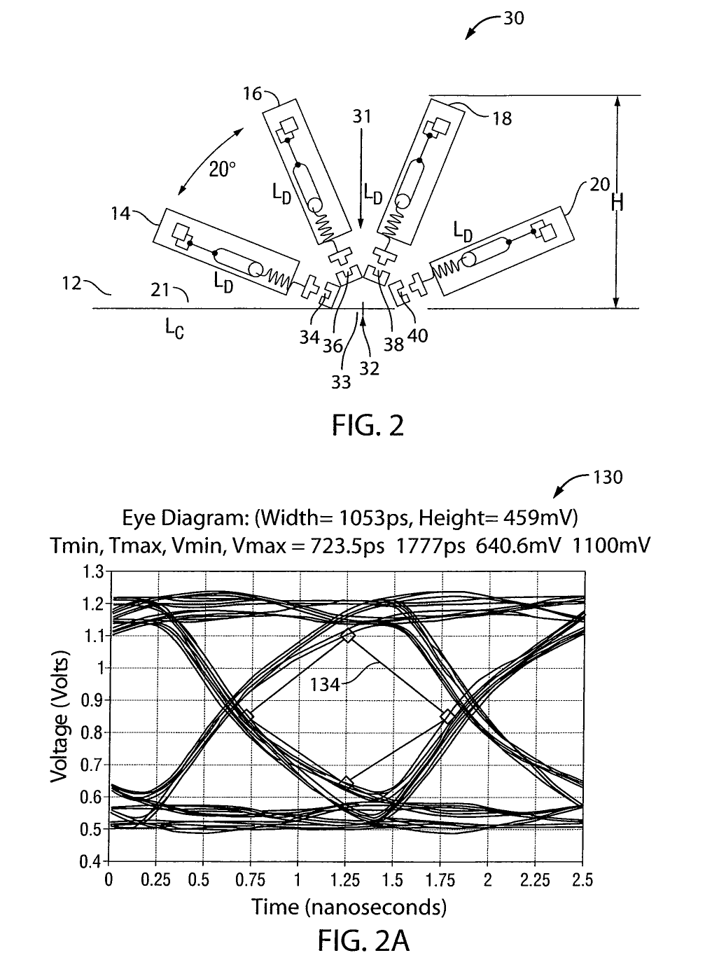

FIG. 2 is a schematic diagram of a memory system 30 wherein the four DIMMs 14, 16, 18, 20 are configured with a more balanced topology according to the invention. The memory system 30 includes a four-DIMM connector referred to herein as a Quad Radial connector 31. The Quad Radial connector 31 has four DIMM sockets (which may be referred to as slots) 34, 36, 38, 40 for receiving the DIMMs 14, 16, 18, 20. The DIMMs are disposed in a generally radially oriented, angularly spaced arrangement about the Quad Radial connector 31. The Quad Radial connector 31 provides a common “memory module junction” 32 connecting the four DIMMs 14, 16, 18, 20 in parallel to the CPU 12. Because the memory modules in this embodiment are DIMMs, the memory module junction 32 may be referred to as the DIMM socket junction 32. I/O signals to and from each of the four DIMMs 14, 16, 18, 20 and the CPU 12 all pass through the DIMM socket junction 32. As a result, these I/O signals travel along substantially the same path length and to avoid an impedance mismatch. This more balanced topology improves memory speed and performance by both equalizing communication path lengths and by reducing or eliminating impedance mismatch.

In addition to the numerous benefits provided by the electronic configuration of the memory system 30, the mechanical layout of the DIMMs 14, 16, 18, 20 in FIG. 2 is also very efficient and compact. The use of the Quad Radial connector 31 having the DIMM socket junction 32 in lieu of four separate, spaced-apart, conventional DIMM connectors (as in the prior art memory system 20 of FIG. 2) reduces part count, and reduces the surface area (“footprint”) occupied by the memory system 30 on the motherboard or other circuit board to which the Quad Radial connector 31 may be mounted. The Quad Radial connector 31 includes four DIMM sockets 34, 36, 38, 40 arranged so that the DIMMs radially extend from and are angularly spaced about a reference centerline 33 that typically lies in or parallel to the motherboard. The DIMMs 14, 16, 18, 20 are optionally equally spaced about the centerline 33. The angling of the DIMMs also reduces a profile height (H) as compared with a conventional connector disposed orthogonally to a motherboard. The reduced profile height (H) allows the memory system 30 to be disposed in a more compact server housing. The angle of the DIMMs with respect to a motherboard may be selected such that the profile height (H) is equal to or less than the height of a VLP DIMM conventionally mounted orthogonally to a motherboard. In the memory system 30 shown in FIG. 2, an angular spacing between DIMMs is about 20 degrees, but other angles may be chosen. For example, the angular spacing between any two DIMMs may be as small as 15 degrees or as large as 90 degrees, and the spacing between any two adjacent DIMMs does not have to be the same. Although the memory system 30 includes four DIMM sockets 34, 36, 38, 40 and four respective DIMMs 14, 16, 18, 20, other embodiments may include a different number of DIMMs and DIMM sockets. The DIMMs are not required to be evenly spaced.

FIG. 2A is an eye diagram 130 of the voltage seen by the DIMM 20 in the memory system 30 of FIG. 2. The improved signal quality of the memory system 30 (FIG. 2) relative to the conventional memory system 10 (FIG. 1) is evident by comparing the eye diagram 130 of FIG. 2A to the eye diagram 120 of FIG. 1A. The eye diagram 130 has a more “open eye” characteristic, generally indicated at 134. The open eye 134 has a width of 1053 picoseconds and a height of 459 mV, making it much larger than the eye 124 of FIG. 1A. The eye diagram 130 demonstrates the improved signal quality obtained by the memory system 30. Thus, the memory system 30 can achieve greater performance and reliability than the conventional memory system 10.

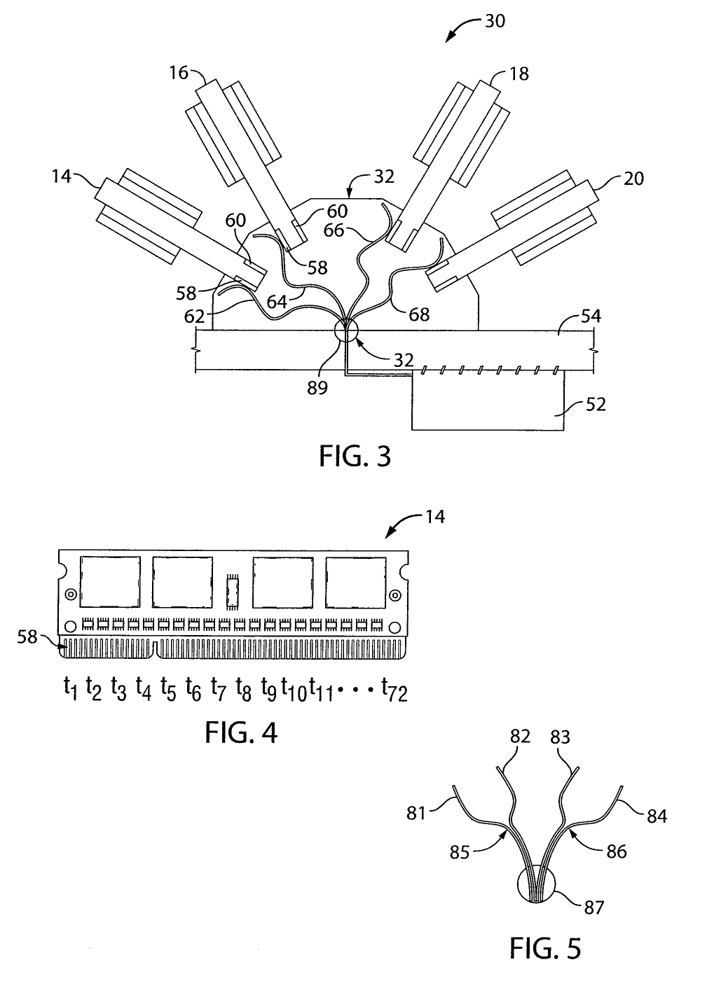

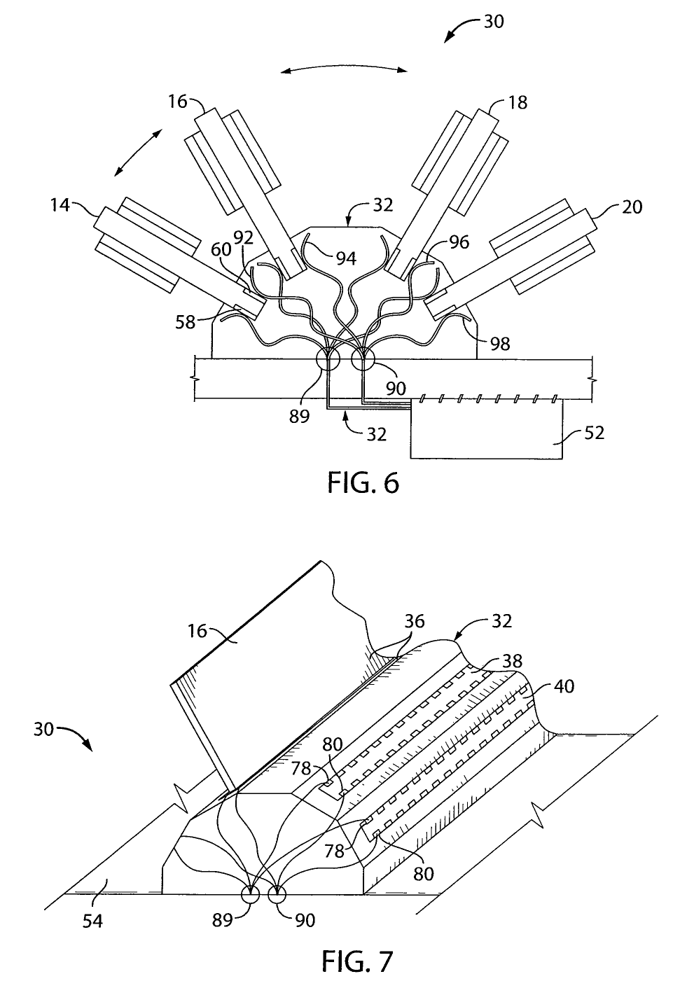

FIG. 3 is a schematic diagram illustrating one example of a wiring configuration for the memory system 30. Each DIMM 14, 16, 18, 20 includes two ordered sets of terminals (“ordered terminal sets”) 58, 60. For simplicity, FIG. 3 illustrates wiring details for the first ordered set 58 and omits the wiring details for the second ordered terminal set 60, which details are discussed below in connection with FIG. 6. Each terminal in the first ordered terminal set 58 may be uniquely designated according to its order in the ordered terminal set 58. For example, FIG. 4 is a plan view of the DIMM 14 including a row of 72 terminals consecutively designated t1 to t72. Typically, the DIMM will include first and second ordered terminal sets 58, 60 that each includes the same number of terminals. Thus, the second ordered terminal set 60 may also include a row of 72 terminals consecutively numbered from t1 to t72, for reference. DIMM terminals having the same reference designation (t1 to t72) may be described as having the “same order,” having “like order,” or having “corresponding order.” Furthermore, each socket in the connector may be referred to as including first and second ordered terminal sets, with each terminal being identified by the same reference designations as the DIM terminals. Accordingly, socket terminals having the same reference designation (t1 to t72) may also be described as having the “same order,” having “like order,” or having “corresponding order.”

DIMM terminals of like order from the first ordered terminal set 58 of each of the four DIMMs 14, 16, 18, 20 are positioned in electronic communication with socket terminals that form part of electronic conductors 62, 64, 66, 68. The electronic conductors 62, 64, 66, 68 extend along equal path lengths and electronically intersect at a node 89. The DIMM socket junction 32 includes a plurality of the nodes 89 corresponding in number to the terminals in the first ordered terminal set 58. In this embodiment, the DIMM socket junction 32 includes 72 nodes 89, each forming an electronic intersection of socket conductors of like order from the first ordered terminal set of the socket (corresponding to the terminals of like order from the first ordered terminal set 58 of each DIMM 14, 16, 18, 20). For example, the “t17” DIMM terminal from each first ordered DIMM terminal set 58 of each DIMM 14, 16, 18, 20 is positioned in electronic communication with the socket terminal from each first ordered socket terminal set, wherein all of the “t17” socket terminals intersect at the 17th node of the 72-node DIMM socket junction 32. Thus, most (but not necessarily all) socket terminals of each DIMM socket are each joined to the same relative terminal of all the other DIMM sockets at the corresponding node 89.

The socket terminals joined in this manner are typically I/O terminals, provided for both input and output to the respective DIMMs 14, 16, 18, 20. Thus, I/O signals may be passed along electronic conductors 62, 64, 66, 68. Examples of I/O signals include data, strobe, and address. Other of the 72 socket terminals may be input-only or output-only terminals, and are typically not joined to the same relative terminal of all the other DIMM sockets. Alternatively, other input-only or output-only terminals may be included, in addition to the 72 terminals of the FIG. 3 embodiment. Other conductors may be provided for communicating input-only or output-only signals to or from the DIMMs 14, 16, 18, 20. Examples of input-only or output-only signals include clock, termination control, DIMM select or chip select, and error reporting.

In the embodiment of FIG. 3, a memory controller 52, which typically comprises a “processor” or a “CPU,” is in communication with the four DIMMs 14, 16, 18, 20 via the DIMM socket junction 32. The memory controller 52 and DIMM socket junction 32 may be secured on a motherboard 54, such as within a server blade, using component-securing techniques known in the art. Read/write signals (one type of I/O signal) sent from the memory controller 52 may travel along the substantially equal-length pathways provided by the conductors 62, 64, 66, 68 to each of the four DIMMs 14, 16, 18, 20. One of the DIMM terminals in each ordered terminal set 58 may be a DIMM selector terminal. The memory controller 52 may generate and send a DIMM-selection signal (one type of input-only signal) along an electronic pathway to the DIMM selector terminal of one of the four DIMMs, to designate which one of the four DIMMs is the intended recipient of a particular read/write signal. The DIMM selection terminals of the respective DIMMs are typically not connected with one another. Thus, the memory controller 52 can generate and send the DIMM-selection signal to a specific one of the four DIMMs 14, 16, 18, 20.

The four equal-length conductors 62, 64, 66, 68 in FIG. 3 are shown to converge at a single point or location, namely, at the node 89 of like order in the DIMM socket junction 32. It should be noted, however, that some of the conductors may meet at locations spaced from the node 89. For example, FIG. 5 illustrates an alternative electrical configuration of four equal-length conductors 81-84 joined at a node 87, wherein two of the conductors 81, 82 are joined at a location 85 and the other two conductors 83, 84 are joined at a location 86. All four conductor paths 81-84 are ultimately joined at the node 87. Nevertheless, the electrical configuration of FIG. 5 is still within the scope of the invention. The four conductors 81-84 still provide equal length pathways to the node 87.

FIG. 6 is a schematic diagram of the memory system 30 illustrating the exemplary wiring diagram of FIG. 3, along with additional details about the wiring corresponding to the second ordered terminal set 60 of each DIMM 14, 16, 18, 20. The DIMM terminals of like order from the second ordered terminal set 60 of each of the four DIMMs 14, 16, 18, 20 are positioned in electronic communication with the memory controller 52 by contact with the terminals of conductors 92, 94, 96, 98, which extend along equal path lengths to a node 90. The number of nodes 90 is typically equal to the number of terminals in the ordered terminal set 60, which in this embodiment would result in 72 nodes 90 corresponding by order to the 72 terminals of each ordered terminal set 60. For example, the “t17” terminal from each second ordered terminal set 60 of each DIMM 14, 16, 18, 20 is positioned in electronic communication with the socket terminal from each first ordered socket terminal set, wherein all of the “t17” socket terminals intersect at the 17th of 72 nodes 90 included with the DIMM socket junction 32. It may be observed that the nodes 89 corresponding to the first ordered terminal set 58 are separate from the nodes 90 corresponding to the second ordered terminal set 60. Furthermore, the limited detail provided in the plane of FIG. 6 shows the conductors 92, 94, 96, 98 overlapping. However, the like ordered conductors 92, 94, 96, 98 of the second ordered set may be electrically insulated and/or routed around each other as necessary to avoid any electrical intersection with any of the like ordered conductors 62, 64, 66, 68 (FIG. 3) of the first ordered set.

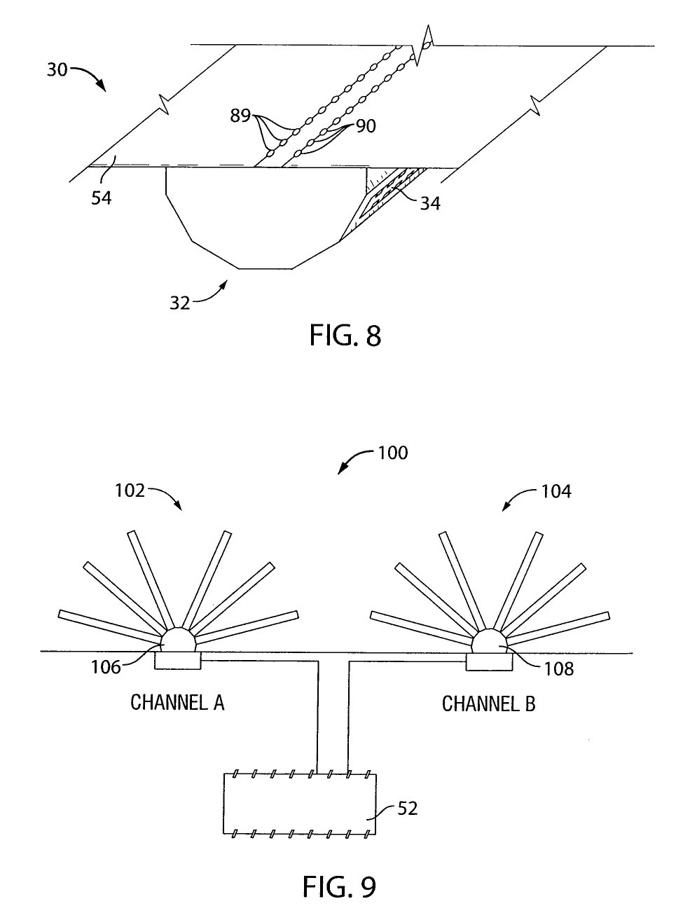

FIG. 7 provides a perspective view of the memory system 30. The slot-like aspect of the DIMM sockets 36, 38, and 40 are visible in this view. The DIMM 16 is shown inserted in its respective DIMM socket (DIMM slot) 36. The DIMMs are removed from DIMM slots 38 and 40, exposing the ordered sets of terminals 58, 60. The “t1” socket terminals of each DIMM socket 34, 36, 38 are shown joined to the “t1” order of the plurality of nodes 89, 90, in the manner shown and described in connection with FIG. 6. FIG. 8 provides another perspective view of the memory system 30, inverted with respect to the view of FIG. 7. The plurality nodes 89, 90 can also be seen in the sectioned underside of the motherboard 54. The memory controller (not shown in this view) is typically in electrical communication with the nodes 89, 90 using conductive traces disposed along the motherboard 54.

Conventional two-channel memory systems are currently limited to two-channel, four-DIMM per channel arrangements. Such conventional systems typically have a series of DIMMs in an alternating (Channel A/Channel B) daisy-chain arrangement. The improved signal quality provided by the present invention will allow memory systems to now surpass this two-channel, four-DIMM per channel limitation. FIG. 9 is a schematic diagram of an embodiment of a two-channel, six-DIMM per channel memory system 100 according to the invention. A first channel memory 102 is in communication with the memory controller 52 on a first channel (“Channel A”), and a second channel memory 104 is in communication with the memory controller 52 on a second channel (“Channel B”). The first and second channel memories 102, 104 each include multiple DIMMs radially oriented and angularly-spaced about a connector body 106. The connector bodies 106, 108 each include six DIMM slots for receiving a total of six DIMMs. Also, whereas conventional two-channel DIMM systems are limited to daisy-chain type configurations, the embodiment of FIG. 9 allows all of the DIMMs of a channel around a single DIMM connector having a shared DIMM socket junction according to the invention.

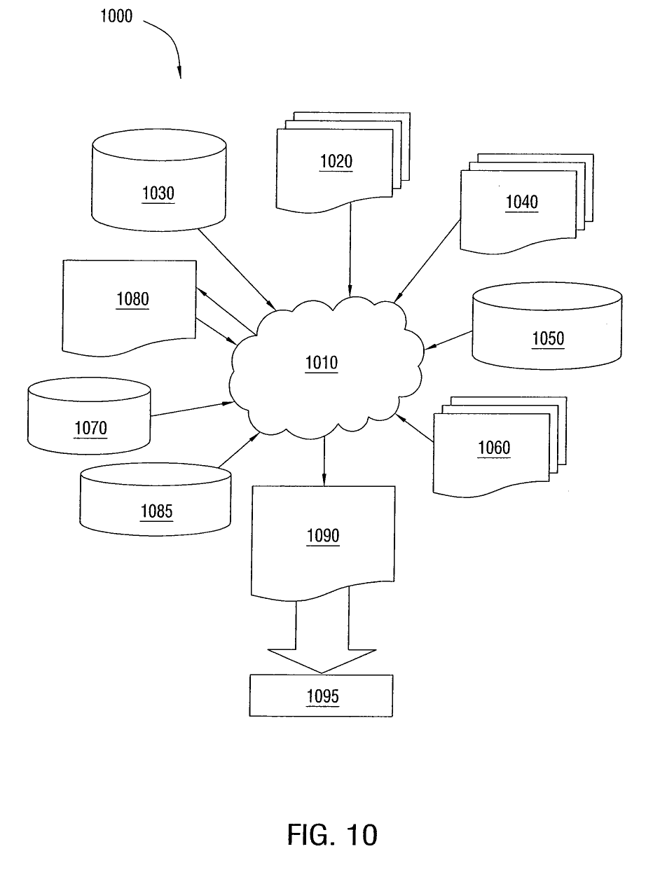

FIG. 10 shows a block diagram of an exemplary design flow 1000 used for example, in mechanical design, manufacturing, and/or test. Design flow 1000 may vary depending on the type of mechanical device or structure being designed. For example, a design flow 1000 for building a custom device or structure may differ from a design flow 1000 for designing a standard component. Design structure 1020 is preferably an input to a design process 1010 and may come from a provider, a developer, or other design company or may be generated by the operator of the design flow, or from other sources. Design structure 1020 comprises the devices or structures described above and shown in FIGS. 2, 3, and 5-9 in the form of schematics. Design structure 1020 may be contained on one or more machine readable medium. For example, design structure 1020 may be a text file or a graphical representation of a device or structure as described above and shown in FIGS. 2, 3, and 5-9. Design process 1010 (e.g., a computer-aided design (CAD) process) preferably translates the devices and structures described above and shown in FIGS. 2, 3, and 5-9 into different data formats and/or representations 1080, where the different data formats and/or representations 1080 include, for example, geometries (wireframe, surface and solid) and other attributes such as metadata, assembly structure and feature data, which describe the mechanical device or structure. The different data formats and/or representations may be subsequently recorded on at least one of machine readable medium. For example, the medium may be a storage medium such as a CD, a compact flash, other flash memory, or a hard-disk drive. The medium may also be a packet of data to be sent via the Internet, or other networking suitable means.

Design process 1010 may include using a variety of inputs; for example, inputs from library elements 1030 which may house a set of commonly used elements, and devices, including models and symbolic representations, for a given manufacturing technology, design specifications 1040, characterization data 1050, verification data 1060, design rules 1070, and test data files 1085 (which may include test patterns and other testing information). Design process 1010 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1010 without deviating from the scope and spirit of the invention. The design structure of the invention is not limited to any specific design flow.

Design process 1010 preferably translates a design or structure as described above and shown in FIGS. 2, 3, and 5-9, along with any additional mechanical design or data (if applicable), into a second design structure 1090. Design structure 1090 resides on a storage medium in a data format used for the exchange of data of mechanical devices and structures (e.g. information stored in a IGES, DXF, Parasolid XT, JT, DRG, or any other suitable format for storing such mechanical design structures). Design structure 1090 may comprise information such as, for example, test data files, design content files, manufacturing data, layout parameters, shapes, data for routing through the manufacturing line, and any other data required by a manufacturer to produce a device or structure as described above and shown in FIGS. 2, 3, and 5-9. Design structure 1090 may then proceed to a stage 1095 where, for example, design structure 1090: is released to manufacturing, is sent back to the customer, etc.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A design structure embodied in a machine readable storage medium for at least one of designing, manufacturing, and testing a design, the design structure comprising:
a memory module system, comprising a plurality of memory modules connected in parallel at a memory module junction in communication with a memory controller, wherein the memory module junction electrically joins terminals of each memory module to the same relative terminals of the other memory modules along electronic pathways of substantially equal length.

2. The design structure of claim 1, wherein the memory modules are angularly spaced with respect to each other.

3. The design structure of claim 1, wherein the memory modules are radially oriented with respect to the memory module junction.

4. The design structure of claim 1, wherein impedance between the memory controller and the memory module junction is matched with impedance between the memory module junction and each of the memory modules.

5. The design structure of claim 1, wherein the impedance between each of the memory modules and the memory module junction are substantially equal.

6. The design structure of claim 1, wherein each memory module comprises a DIMM, wherein the system further comprises a memory module selection terminal included with each DIMM and in communication with the memory controller, wherein the memory controller transmits a memory module selection signal to a selected one of the memory modules for selecting a memory module to read from or write to.

7. The design structure of claim 1, wherein adjacent memory modules have an angular spacing of between about 15 and 90 degrees.

8. The design structure of claim 1, further comprising a second plurality of memory modules connected in parallel at a second memory module junction in communication with the memory controller, wherein terminals of each of the second plurality of memory modules are each joined to the same relative terminal of the other of the second plurality of memory modules along electronic pathways of substantially equal length.

9. The design structure of claim 1, wherein the design structure comprises a data format, which describes the memory module system.

10. The design structure of claim 9, wherein the data format is selected for the exchange of data of mechanical devices and structures.

11. A design structure embodied in a machine readable storage medium for at least one of designing, manufacturing, and testing a design, the design structure comprising:
a memory module connector, comprising:
a connector body having a plurality of memory module sockets each configured for receiving a respective memory module, each memory module socket having an ordered set of terminals for electronic engagement with a corresponding ordered set of terminals on the respective memory module; and
a plurality of electronic pathways of substantially equal length electronically connecting terminals of corresponding order on the memory module sockets to a node.

12. The design structure of claim 11, wherein the electronic pathways are of substantially equal impedance.

13. The design structure of claim 11, wherein the plurality of memory module sockets is configured to position the respective memory modules in a generally radially-oriented position about a centerline, wherein a proximal edge of each memory module is substantially parallel to and equidistant from the centerline.

14. The design structure of claim 11, further comprising a memory controller in electrical engagement with the memory module sockets along the plurality of electronic pathways.

15. The design structure of claim 11, wherein each memory module socket includes a second ordered set of terminals for electronic communication with a corresponding second ordered set of terminals on the respective memory module, and a second plurality of electronic pathways of substantially equal length electronically connecting terminals of corresponding order on the second plurality of memory module sockets to a node.

16. The design structure of claim 15, wherein the memory module sockets of the connector body are electronically controlled on a first channel and the memory module sockets of the second connector body are controlled on a second channel.

17. The design structure of claim 11, further comprising a memory module selection terminal included with each memory module socket and a memory controller in electronic communication with the memory module selection terminals, wherein the memory controller transmits a memory module selection signal to a selected one of the memory modules for selecting a memory module to read from or write to.

18. The design structure assembly of claim 11, wherein adjacent memory module sockets are configured to position the respective memory modules with an angular spacing of between about 15 and 90 degrees.

19. The design structure of claim 11, wherein the design structure comprises a data format, which describes the memory module connector.

20. The design structure of claim 19, wherein the data format is selected for the exchange of data of mechanical devices and structures.
